(19) United States
(12) Patent Application Publication
(10) Pub. No.: US 2026/0166946 A1
(43) Pub. Date: Jun. 18, 2026

(54) FLUID DISTRIBUTOR VALVE WITH TEMPERATURE SENSOR

(71) Applicant: Stoneridge Control Devices, Inc., Novi, MI (US)

(72) Inventor: Robert James Steinman, Lexington, OH (US)

(21) Appl. No.: 18/979,925

(22) Filed: Dec. 13, 2024

(51) Int. Cl. B60H 1/00; F16K 37/00; G01K 13/02

(52) U.S. Cl. CPC B60H 1/00485; F16K 37/0091; G01K 13/02; G01K 2201/02

(57) ABSTRACT

A coolant distributor valve for a vehicle cooling system includes a housing that includes a valve body portion with multiple fluid ports respectively providing multiple fluid passages, a rotary valve that is arranged in the valve body portion and has multiple fluid openings, the rotary valve is configured to rotate about a valve axis between multiple flow positions arranging the multiple fluid openings relative to the multiple fluid passages. The rotary valve includes an aperture that is arranged radially inward from the multiple fluid openings, and a temperature sensor that is aligned with the aperture in each of the multiple flow positions. The temperature sensor is configured to detect a coolant temperature within the rotary valve.

### TECHNICAL FIELD

This disclosure relates to a fluid distributor valve for use in vehicle cooling systems, for example.

### BACKGROUND

A typical modern vehicle includes various components and subsystems for which it is desirable to regulate the temperature (i.e., heating and/or cooling to a desired temperature). One or more cooling loops include one or more heat exchangers through which one or more fluids are circulated in a controlled manner to provide cooling fluid at a desired temperature to the components. As vehicles have become more complex, the complexity of the cooling system has increased as well.

A typical cooling system found in vehicles such as those having electrified and/or hybrid drivetrains tend to be highly distributed architectures with a complex maze of cooling loops, sub-loops, pumps, and heat exchanges. Coolant distributor valves, controllers and temperature sensors used to direct the coolant through these cooling systems are separated from one another and distributed throughout the vehicle. The resultant cooling system is complicated and expensive to implement and maintain, and the coolant temperature may not be as accurately regulated as desired.

A coolant distributor valve has been proposed that includes the temperature sensor within the assembly. This configuration encapsulates the temperature sensor using the housing so that no portion of the sensor is in contact with the fluid.

### SUMMARY

In one exemplary embodiment, a coolant distributor valve for a vehicle cooling system includes a housing that includes a valve body portion with multiple fluid ports respectively providing multiple fluid passages, a rotary valve that is arranged in the valve body portion and has multiple fluid openings, the rotary valve is configured to rotate about a valve axis between multiple flow positions arranging the multiple fluid openings relative to the multiple fluid passages. The rotary valve includes an aperture that is arranged radially inward from the multiple fluid openings, and a temperature sensor that is aligned with the aperture in each of the multiple flow positions. The temperature sensor is configured to detect a coolant temperature within the rotary valve.

In a further embodiment of any of the above, the housing includes an electronics portion, and includes a printed circuit board (PCB) that is arranged in the electronics portion. The temperature sensor is electrically connected to the PCB and supported by the electronics portion. A motor is arranged in the electronics portion and electrically connected to the PCB, and a gear train is coupled between the motor and the rotary valve. The valve body portion and the electronics portion are secured to one another.

In a further embodiment of any of the above, the temperature sensor extends at least partially into the aperture.

In a further embodiment of any of the above, the temperature sensor extends through the aperture.

In a further embodiment of any of the above, the valve body portion includes a hole, and the temperature sensor extends through the hole.

In a further embodiment of any of the above, the rotary valve has a circular perimeter, and the multiple fluid openings are arranged in the circular perimeter. The temperature sensor is located radially inward within the circular perimeter.

In a further embodiment of any of the above, the rotary valve includes a floor through which the valve axis extends and which joins the circular perimeter. The aperture is provided in the floor.

In a further embodiment of any of the above, the coolant distributor valve includes multiple seals that are arranged between and in engagement with the circular perimeter and the valve body portion. Each one of the multiple seals circumscribes a corresponding one of the multiple fluid passages.

In a further embodiment of any of the above, the aperture is an arcuate slot.

In a further embodiment of any of the above, the aperture has opposing sides, and the valve body includes at least one reinforcing bridge that extends over the aperture and interconnects the opposing sides.

In a further embodiment of any of the above, the temperature sensor is located in a different position relative to the arcuate slot in each of the multiple fluid flow positions.

In a further embodiment of any of the above, the temperature sensor has a sensor axis that is parallel with the valve axis.

In a further embodiment of any of the above, a vehicle cooling system including the coolant distributor valve includes multiple cooling loops. The coolant distributor valve interconnects at least two of the multiple cooling loops, and the valve is configured to move between multiple positions to direct a desired cooling flow through the at least two of the multiple cooling loops based upon the detected coolant temperature.

In a further embodiment of any of the above, the cooling loops include at least two of a battery, a vehicle cabin, a charging electronics and a motor.

In another exemplary embodiment, a method of assembling a coolant distributor valve includes arranging a temperature sensor that is connected to a printed circuit board (PCB) into an electronics portion, inserting a shaft of a rotary valve into the electronics portion and aligning the temperature sensor with an aperture in the rotary valve, securing a valve body portion to the electronics portion and over the rotary valve, the valve body portion has multiple fluid ports that respectively provide multiple fluid passages. The rotary valve includes multiple fluid openings that are configured to be arranged relative to the multiple fluid passages in multiple flow positions.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic of one example vehicle cooling system.

FIG. 2 is a schematic view of a disclosed coolant distributor valve with integrated temperature sensor.

FIGS. 3A and 3B are respectively perspective and cross-sectional views view of a disclosed coolant distributor valve.

FIGS. 4A and 4B are respectively side and top views of one example rotary valve.

FIGS. 5A-5C are respectively a perspective view of an example 4-port coolant distributor valve, a cross-sectional view of the example 4-port coolant distributor valve, and a perspective view of one example rotary valve.

FIGS. 6A-6C illustrates the coolant distributor valve shown in FIGS. 5A-5C in three different flow positions.

FIGS. 7A-7C illustrates the coolant distributor valve shown in FIGS. 5A-5B with a different rotary valve, and the coolant distributor valve is shown in three different flow positions.

FIGS. 8A-8C the coolant distributor valve shown in FIGS. 5A-5B with a different rotary valve, and the coolant distributor valve is shown in three different flow positions.

FIGS. 9A and 9B are respectively a perspective view of an example 5-port coolant distributor valve, and a cross-sectional view of the example 5-port coolant distributor valve.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

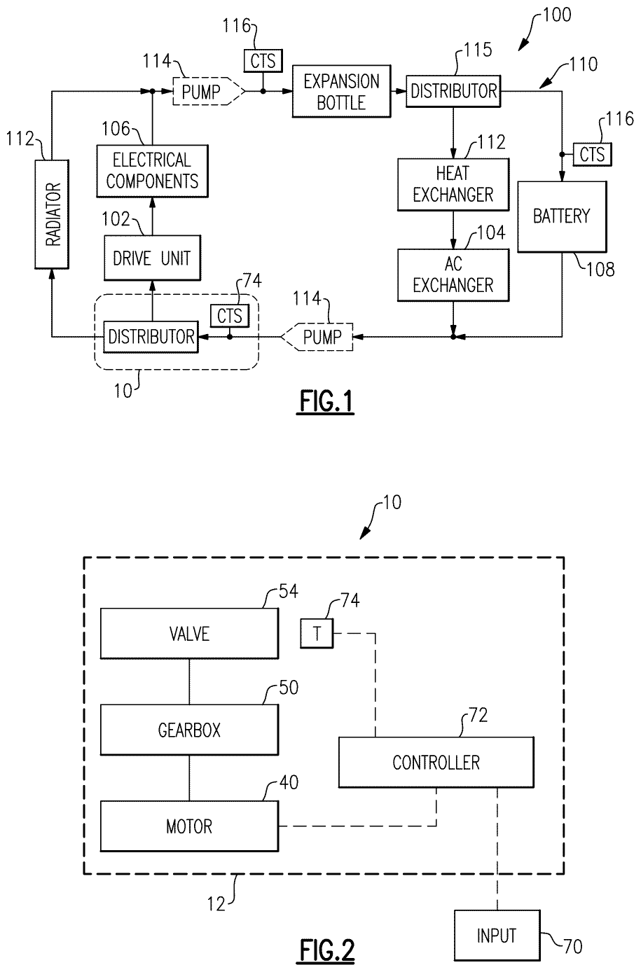

FIG. 1 depicts some aspects of a typical example vehicle cooling system 100, which is highly schematic and for illustrative purposes only. The system 100 tends to be relatively complex and include numerous loops, sub-loops, and branches for carrying a cooling fluid, such as a liquid coolant (e.g., water ethylene glycol). One type of vehicle includes one or more motors 102, an occupant cabin thermal conditioning system 104, a charging system 106, and a battery 108. One or more cooling loops 110 circulate the coolant through these components. Typically, multiple heat exchangers 112 are disbursed throughout the cooling loops 110 to provide a heat exchange from the coolant to another fluid such as air or another liquid coolant. One or more pumps 114 circulate the coolant through the cooling loops 110.

Multiple fluid distribution valves 115 connect multiple passages to selectively regulate the flow of coolant, and thus its temperature, through the cooling loops 110. The fluid distribution valves 115 are distributed throughout the cooling loop 110 as well as throughout the vehicle. Numerous temperature sensors 116 are also disbursed throughout the cooling system 100 to monitor the temperature at various locations in order to enable coordination of the various components to achieve desired temperatures throughout the system. The disclosed coolant distributor valve 10 integrates a temperature sensor 74 in the same assembly for increased temperature sensing accuracy.

Referring to FIG. 2, the coolant distributor valve 10 includes housing 12 enclosing a valve 54 that is movable between multiple flow positions in response to being driven by an electric motor 44 and gear train 50, if desired. A controller (e.g., PCB) 72 may also be provided in the housing 12 for providing motor control in response to an input 70. The disclosed coolant distributor valve 10 integrates the temperature sensor 74 into the assembly in a reliable way that also provides more accurate temperature sensing, and therefore improved overall temperature regulation by the cooling system 100.

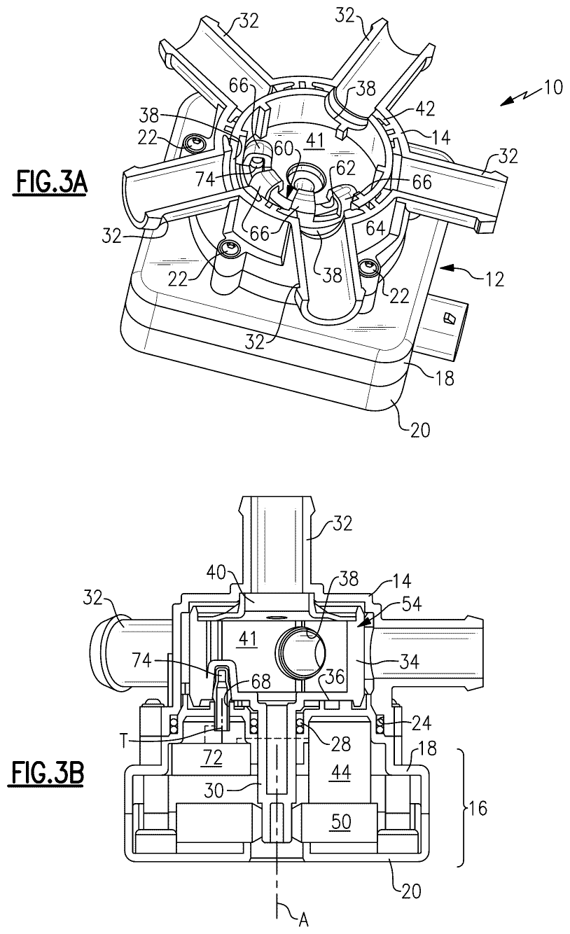

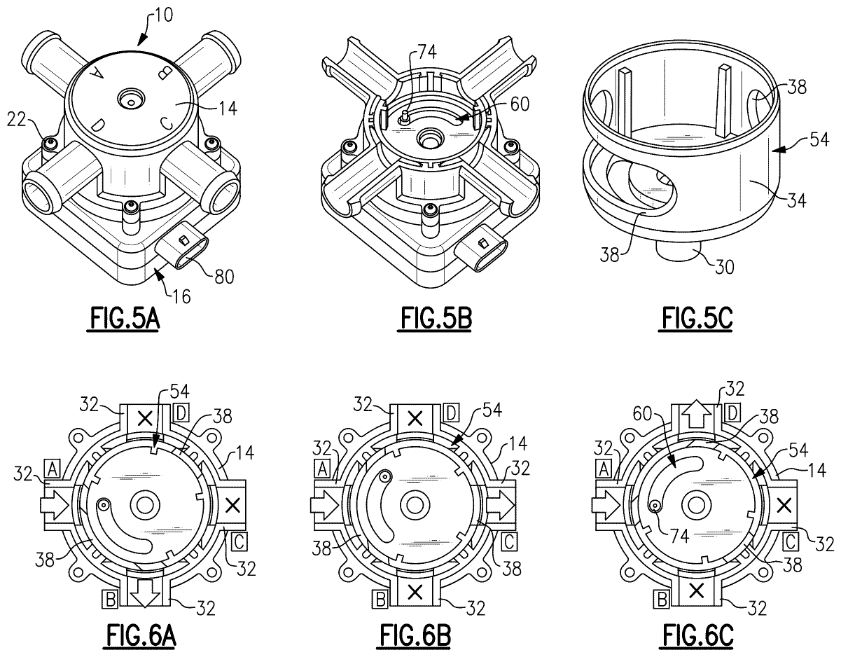

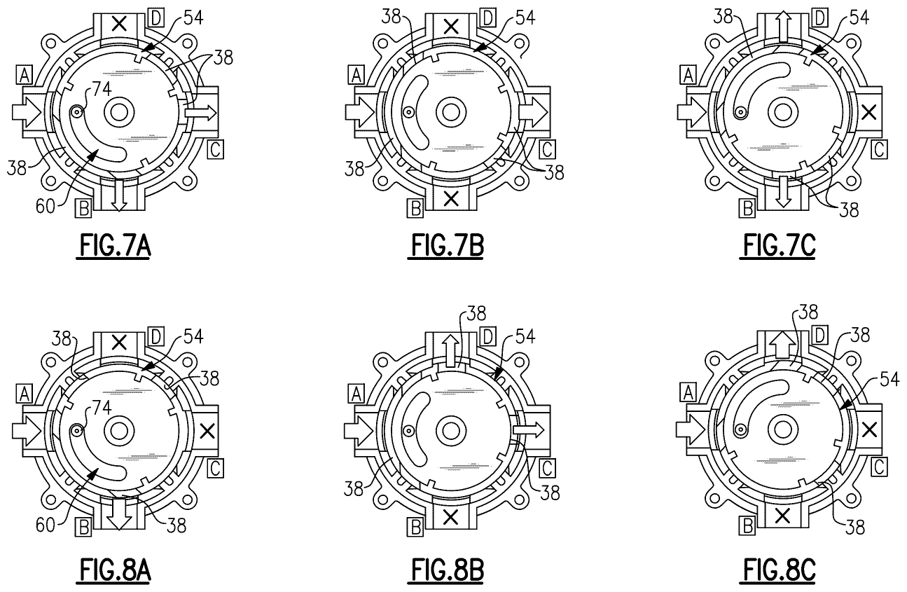

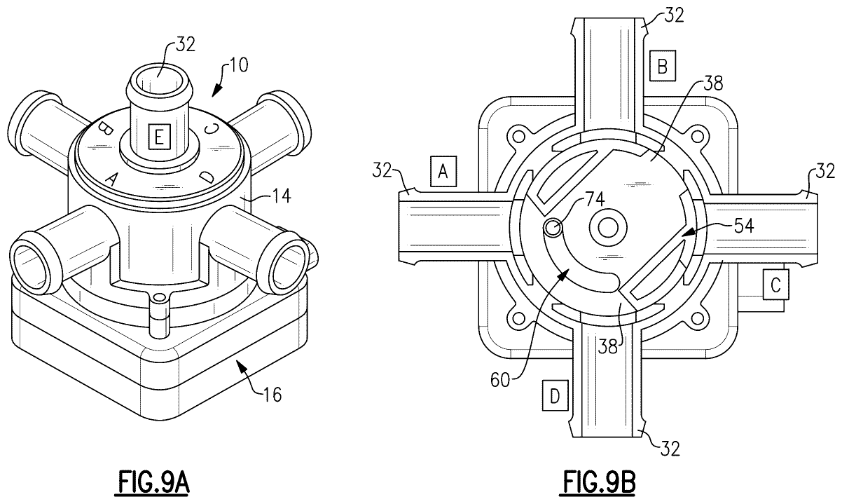

An example coolant distributor valve 10 is shown in FIGS. 3A-3B. In this illustrated example, a 6-port configuration is shown. Other configurations may be provided such as a 4-port arrangement (e.g., FIGS. 5A-6C; FIGS. 7A-7C; FIGS. 8A-8C) or a 5-port arrangement (e.g., FIGS. 9A-9B). However, this disclosure should not be understood as limiting the configuration of the valve or number of ports, as more or fewer ports may be provided that the depicted examples.

The coolant distributor valve 10 is constructed with a multi-piece housing 12 with multiple portions that are secured to one another by one or more attachment techniques (e.g., welding, fasteners, glue, sealant, etc.). In the example, there are two main housing portions: a valve body portion 14 and an electronics portion 16 secured to one another by fasteners 22. In one example, the electronics portion 16 is provided by first and second housing portions 18, 20 that enclose the motor 44, gear train 50 (if used) and PCB 72 (if used) to fluidly separate these components protected from coolant. One or more seals 24 are provided between the valve body portion 14 and the electronics portion 16 to prevent coolant from escaping the housing 12.

The valve body portion 14 provides multiple fluid ports 32 respectively providing multiple fluid passages that carry fluid into and out of the valve 10. The rotary valve 54 includes a shaft 30, coupled to the gear train 50, rotatable about a valve axis A. The shaft 30 extends into the electronics portion 16 and is sealed relative thereto by one or more seals 28. The valve 54 has multiple fluid openings 38 in its periphery. The valve 54 is configured to rotate between multiple flow positions in which the fluid openings 38 are positioned relative to the multiple fluid passages to selectively block and unblock one or more ports to regulate the flow of coolant (e.g., water ethylene glycol) through the cooling system 100.

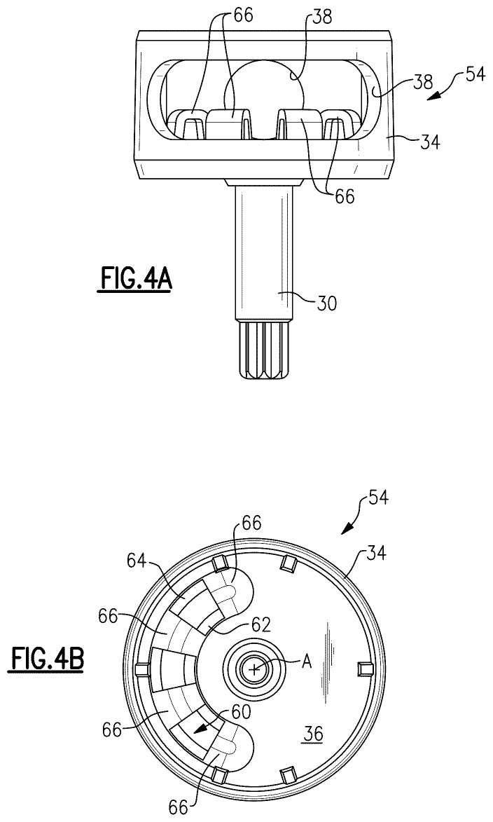

The rotary valve 54 has a peripheral wall 34 (e.g., cylindrical or spherical) that provides a circular perimeter in which the fluid openings 38 are arranged. A floor 36 through which the valve axis A extends joins the circular perimeter, and a wall 40 (provided by a separate cap in the illustrated example) is arranged opposite the floor 36 to provide a valve cavity 41. Another example rotary valve 54 with a different opening 38 configuration is shown in FIGS. 4A-4B. Multiple seals 42 are arranged between and in engagement with the circular perimeter and the valve body portion 14, such that each one of the multiple seals 42 circumscribe a corresponding one of the multiple fluid passages provided by the ports 32.

In the example, the temperature sensor 74 has a sensor axis T that is parallel with the valve axis A. In the example, the temperature sensor 74, which may be a thermistor, extends through a hole 68 in the valve body portion 16 such that the temperature sensor 74 is exposed directly to coolant in the valve cavity 41 to get a very accurate reading. That is, in the example, the temperature sensor 74 is not obstructed by the housing 12 at its temperature sensing portion. Sealant can be used between the temperature sensor 74 and the valve body portion 16 to prevent leakage.

The temperature sensor 74 is arranged to have direct fluid communication with the coolant within the valve cavity 42, located radially inward within the circular perimeter (and, thus, radially inward from the multiple fluid openings 38). In the example, the floor 36 includes an aperture 60 provided as an arcuate slot. The temperature sensor 74 extends at least partially into the aperture 60, and may extend through the aperture 60, as shown. The aperture 60 has opposing sides 62, 64, and the valve 54 includes at least one reinforcing bridge 66 extending over the aperture 60 to interconnect the opposing sides 62, 64 to provide more rigidity. The temperature sensor 74 remains aligned with the aperture 60 (i.e., exposed to coolant) in each of the multiple flow positions, but is located in a different position relative to the arcuate slot in each of the multiple fluid flow positions.

The coolant distributor valve 10 diverts coolant from one or more input ports to one or more output ports provided by the fluid connections 32 and thereby connects at least two cooling loops (e.g., including at least two of a battery, a vehicle cabin, a charging electronics and a motor). Moving the valve 54 between multiple positions directs a desired cooling flow through the at least two of the multiple cooling loops based upon the detected coolant temperature. By placing the temperature sensor 74 in the coolant distributor valve 10 where the coolant will have mixed from the fluid passages, the temperature taken by the temperature sensor 74 is much more accurate and, thus, useful for evaluating which port to open or close or for providing information on other subsystems (i.e., zones in the cooling system 100) through which the coolant is flowing. For example, if the coolant distributor valve 10 and integrated temperature sensor 74 is connected to a battery 108, electrical charging voltage converter 106, electric motor 102, and/or a passenger cabin thermal conditioning system 104, it can collect temperature information from the coolant and help an internal (e.g., PCB 72) or external control unit make a much more accurate determination on what subsystem needs coolant or does not need coolant.

The controller (e.g., PCB 72) may be a hardware device for executing software, particularly software stored in memory. The controller (e.g., PCB 72) can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller (e.g., PCB 72) is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The disclosed coolant distributor valve is assembled by arranging the temperature sensor 74 and PCB 72 into the electronics portion 16 along with the motor 44 and gear train 50. The temperature sensor 74 is inserted through the hole 68. In the example, the first and second portions 18, 20 of the electronics portion 16 are sealed about these components. The shaft 30 of the rotary valve 54 is inserted into the electronics portion 16 to couple the rotary valve 54 to the gear train 50. The temperature sensor 74 is aligned with the aperture 60 so that the temperature sensor 74 is directly exposed to coolant in the valve cavity 41 throughout rotation of the rotary valve 54 when in use. The valve body portion 14 is secured to the electronics portion 16 and over the rotary valve 54.

The valve body portion 14 has multiple fluid ports 32 in other example configurations respectively providing multiple fluid passages (e.g., shown in FIGS. 5A-8B). The rotary valve 54 includes multiple fluid openings 38 configured to be arranged relative to the multiple fluid passages in multiple flow positions depending upon the design of the cooling system 100. An “X” indicates blocked flow to the port in the position shown, whereas an arrow illustrates fluid flow through the port. The directions of the arrows are examples of possible flow directions, but may be different if desired.

FIGS. 5A-5C are respectively a perspective view of an example 4-port coolant distributor valve, a cross-sectional view of the example 4-port coolant distributor valve, and a perspective view of one example rotary valve. FIGS. 6A-6C illustrates the coolant distributor valve shown in FIGS. 5A-5C in three different flow positions. FIGS. 7A-7C illustrates the coolant distributor valve shown in FIGS. 5A-5B with a different rotary valve, and the coolant distributor valve is shown in three different flow positions. FIGS. 8A-8C the coolant distributor valve shown in FIGS. 5A-5B with a different rotary valve, and the coolant distributor valve is shown in three different flow positions.

FIGS. 9A and 9B are respectively a perspective view of an example 5-port coolant distributor valve, and a cross-sectional view of the example 5-port coolant distributor valve. In this example, reinforcing bridged extending over the aperture 60 are omitted.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A coolant distributor valve for a vehicle cooling system, comprising:
a housing including a valve body portion with multiple fluid ports respectively providing multiple fluid passages;
a rotary valve arranged in the valve body portion and having multiple fluid openings, the rotary valve configured to rotate about a valve axis between multiple flow positions arranging the multiple fluid openings relative to the multiple fluid passages, the rotary valve includes an aperture arranged radially inward from the multiple fluid openings; and
a temperature sensor aligned with the aperture in each of the multiple flow positions, wherein the temperature sensor is configured to detect a coolant temperature within the rotary valve.

2. The coolant distributor valve of claim 1, where the housing includes an electronics portion, and comprising:
a printed circuit board (PCB) arranged in the electronics portion, the temperature sensor electrically connected to the PCB and supported by the electronics portion;
a motor arranged in the electronics portion and electrically connected to the PCB, and a gear train coupled between the motor and the rotary valve; and
wherein the valve body portion and the electronics portion are secured to one another.

3. The coolant distributor valve of claim 1, wherein the temperature sensor extends at least partially into the aperture.

4. The coolant distributor valve of claim 3, wherein the temperature sensor extends through the aperture.

5. The coolant distributor valve of claim 1, wherein the valve body portion includes a hole, and the temperature sensor extends through the hole.

6. The coolant distributor valve of claim 1, wherein the rotary valve has a circular perimeter, and the multiple fluid openings are arranged in the circular perimeter, the temperature sensor is located radially inward within the circular perimeter.

7. The coolant distributor valve of claim 6, wherein the rotary valve includes a floor through which the valve axis extends and which joins the circular perimeter, the aperture is provided in the floor.

8. The coolant distributor valve of claim 6, comprising multiple seals arranged between and in engagement with the circular perimeter and the valve body portion, each one of the multiple seals circumscribing a corresponding one of the multiple fluid passages.

9. The coolant distributor valve of claim 1, wherein the aperture is an arcuate slot.

10. The coolant distributor valve of claim 9, wherein the aperture has opposing sides, and the valve body includes at least one reinforcing bridge extending over the aperture and interconnecting the opposing sides.

11. The coolant distributor valve of claim 9, wherein the temperature sensor is located in a different position relative to the arcuate slot in each of the multiple fluid flow positions.

12. The coolant distributor valve of claim 1, wherein the temperature sensor has a sensor axis that is parallel with the valve axis.

13. A vehicle cooling system including the coolant distributor valve of claim 1, comprising multiple cooling loops, the coolant distributor valve interconnecting at least two of the multiple cooling loops, and the valve configured to move between multiple positions to direct a desired cooling flow through the at least two of the multiple cooling loops based upon the detected coolant temperature.

14. The vehicle cooling system of claim 13, wherein the cooling loops include at least two of a battery, a vehicle cabin, a charging electronics and a motor.

15. A method of assembling a coolant distributor valve, comprising:
arranging a temperature sensor connected to a printed circuit board (PCB) into an electronics portion;
inserting a shaft of a rotary valve into the electronics portion and aligning the temperature sensor with an aperture in the rotary valve;
securing a valve body portion to the electronics portion and over the rotary valve, the valve body portion having multiple fluid ports respectively providing multiple fluid passages, wherein the rotary valve includes multiple fluid openings configured to be arranged relative to the multiple fluid passages in multiple flow positions.
